(19) United States
(12) Patent Application Publication
(10) Pub. No.: US 2013/0088659 A1
(43) Pub. Date: Apr. 11, 2013

(54) LIQUID CRYSTAL DISPLAY DEVICE

(71) Applicants: Kenji Miyamoto, Osaka-shi (JP); Yusuke Kimura, Osaka-shi (JP); Noboru Teraguchi, Osaka-shi (JP)

(72) Inventors: Kenji Miyamoto, Osaka-shi (JP); Yusuke Kimura, Osaka-shi (JP); Noboru Teraguchi, Osaka-shi (JP)

(73) Assignee: SHARP KABUSHIKI KAISHA, Osaka (JP)

(21) Appl. No.: 13/701,127

(22) PCT Filed: May 27, 2011
(86) PCT No.: PCT/JP2011/002970

§ 371 Date: Nov. 30, 2012

(30) Foreign Application Priority Data
Jun. 2, 2010 (JP) 2010-127007

(51) Int. Cl. G02F 1/1368

(52) U.S. Cl. CPC G02F 1/1368
USPC 349/43

(57) ABSTRACT

A liquid crystal display device includes a counter substrate, a TFT substrate, and a liquid crystal layer enclosed between the counter substrate and the TFT substrate. The TFT substrate has, on a counter surface thereof, a plurality of pixel electrodes arranged in a matrix. The counter substrate has, on a counter surface thereof, a single counter electrode having light transmission capability and facing the pixel electrodes. Voltages applied between the pixel electrodes and the counter electrode have a frequency of less than 60 Hz. The voltages between the pixel electrodes and the counter electrode are periodically reversed. The counter electrode includes a plurality of pixel counter regions facing the respective corresponding pixel electrodes, and a grid region between each of the pixel counter regions. The grid region is located further away from the TFT substrate than the pixel counter regions are.

### TECHNICAL FIELD

The present invention relates to liquid crystal display devices which are driven at a low frequency.

### BACKGROUND ART

In recent years, mobile devices having a large liquid crystal display screen have been proliferating. A battery is typically used as a power supply for driving such a mobile device. There is an increasing demand for a smaller and lighter battery to improve the portability, and therefore, usable power is often limited. Therefore, a reduction in power consumption is key to long-time continuous driving of the mobile device.

For example, a display device suited to displaying of electronic books etc. has been proposed (PATENT DOCUMENT 1). This display device is a reflective active matrix liquid crystal display device which includes thin film transistors (TFTs) or reflection electrodes corresponding to respective pixel electrodes. In the display device, in order to reduce power consumption, the frame frequency is decreased by incorporating a memory to each pixel. Also, a drive control is devised to reduce or prevent flicker which has an adverse influence on displaying.

### CITATION LIST

### Patent Document

PATENT DOCUMENT 1: Japanese Patent Publication No. 2008-176330

### SUMMARY OF THE INVENTION

### Technical Problem

Incidentally, in the display device of PATENT DOCUMENT 1, similar to conventional liquid crystal display devices of the same type, a light blocking layer (black matrix) which covers a portion between adjacent reflection electrodes is provided on a substrate facing the display side.

FIG. 1 shows a display panel 100 for this type of display device. The display panel 100 includes a pair of substrates, i.e., a counter substrate 110 facing the display side and a TFT substrate 120. A liquid crystal layer 130 is enclosed between the substrates 110 and 120 bonded together to form a display region 101 (see FIG. 3). A plurality of pixels 102, 102, . . . , and 102 are provided in a matrix in the display region 101. Pixel electrodes 123 having a reflection function are provided on the TFT substrate 120, corresponding to the respective pixels 102 (one pixel electrode for each pixel). A grid-like light blocking layer 112 which has a larger width than that of a portion (also referred to as an “isolation region 103”) between adjacent pixel electrodes 123 and 123 to cover the isolation region 103 is provided on the counter substrate 110.

When the light blocking layer 112 which blocks light is provided in the display region 101, the aperture ratio decreases proportionately. Therefore, it is preferable that the light blocking layer 112 be reduced or removed in order to improve display performance, such as luminance, contrast, etc.

However, if the frequency of a drive voltage is decreased in order to reduce power consumption as in PATENT DOCUMENT 1, flicker (flicker phenomenon) occurs in the isolation region 103. The isolation region 103 needs to be covered with the light blocking layer 112 in order to hide the flicker. Therefore, the light blocking layer 112 cannot be reduced or removed without careful consideration.

This problem will be described in detail. In the above liquid crystal display device, a drive control of reversing the drive voltage at predetermined intervals is typically performed in order to reduce image sticking etc. Therefore, if the frequency of the drive voltage is decreased to as low as less than 30 Hz, flicker becomes noticeable in the isolation region 103.

For example, FIGS. 2(a) and 2(b) show a portion of the display region 101 during black display, excluding the light blocking layer 112. As shown in FIGS. 2(a) and 2(b), the isolation region 103 repeatedly switches between a dark state shown in FIG. 2(a) and a light state shown in FIG. 2(b), in association with the reversal of the drive voltage. If such luminance changes in the isolation region 103 occur at a conventional frequency of 60 Hz etc., the luminance changes are too fast to recognize and therefore do not raise a problem. However, as the frequency decreases, the luminance changes disadvantageously become noticeable.

FIG. 3 schematically shows a cross-section of the display panel 100 in the display region 101. A TFT layer 122 including TFTs etc., the pixel electrodes 123, etc. are provided on an opposite surface of the TFT substrate 120 with respect to an insulating substrate 121. The pixel electrodes 123 are provided, corresponding to the respective pixels 102, i.e., one pixel electrode 123 is provided for each pixel 102. A counter electrode 113 spreading all over an opposite surface of the counter substrate 110 with respect to an insulating substrate 111. The pixel electrodes 123 each face the counter electrode 113 with the liquid crystal layer 130 being interposed therebetween. Note that, in addition to the above-described components, a polarizing film, an alignment film, etc. are provided in the display region 101, but are not shown for the sake of convenience.

For example, if the liquid crystal display device is a normally white type monochromatic display device, the pixel 102 to which a voltage is not applied transmits reflected external light without absorption, and therefore, the display region 101 corresponding to that pixel 102 appears white. In contrast to this, in the pixel 102 to which a predetermined voltage (e.g., 5 V) is applied between the pixel electrode 123 and the counter electrode 113, the alignment of liquid crystal molecules contained in the liquid crystal layer 130 between the pixel electrode 123 and the counter electrode 113 in that pixel 102 is changed, so that reflected light is absorbed, and therefore, the display region 101 corresponding to that pixel 102 appears black.

As described above, the drive voltage is reversed at predetermined intervals. Therefore, while the voltage is applied to the pixel 102, i.e., black is displayed, the pixel 102 repeatedly switches between a state in which the counter electrode 113 has a higher potential than that of the pixel electrode 123 as shown in FIG. 4(a) and a state in which the counter electrode 113 has a lower potential than that of the pixel electrode 123 as shown in FIG. 4(b).

As shown in FIG. 4(a), for example, when the potential of the counter electrode 113 is 5 V and the potentials of the pixel electrodes 123 are 0 V (i.e., the counter electrode 113 has a higher potential that of the pixel electrodes 123), the isolation region 103 in which an electrode is not provided is in the same state as that which is obtained when a voltage of 5 V is applied, as with the pixel electrodes 123. Therefore, there is substantially no difference in luminance between the pixel electrodes 123 and the isolation region 103, so that the entire display region 101 displays black as shown in FIG. 2(a).

In contrast to this, as shown in FIG. 4(b), for example, when the potentials of the pixel electrodes 123 are 5 V and the potential of the counter electrode 113 is 0 V (i.e., the counter electrode 113 has a lower potential than that of the pixel electrodes 123), a potential difference of 5 V which is the same as that of the case of FIG. 4(a) occurs between the counter electrode 113 and the pixel electrodes 123, but in the isolation region 103, the potential of the isolation region 103 remains 0 V, and therefore, a potential difference does not occur between the isolation region 103 and the counter electrode 113. Actually, even in the isolation region 103, a potential difference of about 3 V occurs with respect to the counter electrode 113 due to an influence of the voltage applied to the pixel electrodes 123. However, the potential difference in the isolation region 103 is smaller than that of the pixel electrodes 123. Therefore, as shown in FIG. 2(b), the isolation region 103 appears whiter than the pixel electrodes 123.

In other words, even when the drive voltage is reversed, the potential difference of the pixel electrode 123 is maintained unchanged, and therefore, substantially no change occurs in the luminance. However, the magnitude of the potential difference changes in the isolation region 103 due to the reversal of the drive voltage, and therefore, the luminance changes periodically. If the frequency of the drive voltage is decreased, the periodic change of the luminance appears to flicker, which causes discomfort to the viewer. Therefore, the light blocking layer 112 is indispensable to conventional liquid crystal display devices in order to reduce or prevent the flicker.

In addition, if dimension variations, imperfect positioning, etc. occurring during manufacture are taken into consideration, the light blocking layer 112 which is wide enough to reliably cover the isolation region 103 needs to be provided, leading to a further decrease in the aperture ratio.

Therefore, it is an object of the present invention to provide a liquid crystal display device in which flicker occurring when a low-frequency drive voltage is used can be reduced, and the light blocking layer can be reduced.

### Solution To The Problem

The occurrence of such flicker is caused by the asymmetric structure that electrodes are provided only on the counter substrate in the isolation region. Therefore, in the present invention, the counter substrate is configured so that the isolation region has a less asymmetric structure.

Specifically, a liquid crystal display device according to the present invention includes a counter substrate facing a display side, a TFT substrate facing the counter substrate, and a liquid crystal layer enclosed between the TFT substrate and the counter substrate. The TFT substrate has, on a counter surface thereof, a plurality of pixel electrodes arranged in a matrix. The counter substrate has, on a counter surface thereof, a single counter electrode having light transmission capability and facing the pixel electrodes.

Display is performed by changing alignment of liquid crystal molecules contained in the liquid crystal layer by controlling voltages applied between the pixel electrodes and the counter electrode. The voltages have a frequency of less than 60 Hz. The voltages between the pixel electrodes and the counter electrode are periodically reversed.

The counter electrode includes a plurality of pixel counter regions facing the respective corresponding pixel electrodes, and a grid region between each of the pixel counter regions. The grid region is located further away from the TFT substrate than the pixel counter regions are.

In the liquid crystal display device thus configured, the frequency of the voltage applied between the pixel electrodes and the counter electrode is less than 60 Hz. Therefore, power consumption can be reduced compared to conventional liquid crystal display devices.

As described above, if the frequency is decreased, flicker occurs when the voltages between the pixel electrodes and the counter electrode are periodically reversed. In this liquid crystal display device, the grid region of the counter electrode is located further away from TFT substrate than the pixel counter regions facing the pixel electrodes are. Therefore, when the potential of the counter electrode is high, the potential difference in the isolation region decreases to be closer to the potential difference which occurs when the potential of the counter electrode is low.

As a result, the change in the luminance due to the reversal of the voltage is reduced, and therefore, flicker can be reduced even if the frequency is decreased. As a result, the light blocking layer can be removed or reduced, whereby the aperture ratio can be improved.

When the voltage having a frequency of 1-30 Hz is used (in this case, flicker is particularly noticeable and causes much discomfort to the viewer in the conventional art), the present invention is particularly effective.

Specifically, the grid region may be located further away from the TFT substrate than the pixel counter regions are, by at least 0.5 μm or more.

In this case, the luminance change can be reduced to a level which the viewer cannot substantially recognize, and therefore, flicker can be stably reduced even in the case of a low frequency.

More specifically, the counter substrate may further include an insulating substrate having light transmission capability, and a plurality of raised layers provided on the counter surface of the insulating substrate, facing the respective corresponding pixel electrodes, having a platform-like shape, and having light transmission capability. The counter electrode may be provided on top of the raised layers, covering the raised layers. Portions of the counter electrode covering the raised layers may be the pixel counter regions, and a portion of the counter electrode covering a region between each of the pixel counter regions and lower than the pixel counter regions may be the grid region.

In this case, only the step of forming the raised layers by patterning is added to the conventional counter substrate manufacturing process. Therefore, the counter substrate can be relatively easily manufactured, resulting in excellent productivity.

For example, a base layer spreading along the counter surface and integrally formed with the raised layers may be provided below the raised layers. The raised layers and the base layer may be formed of a photosensitive resin.

In this case, a counter electrode having high quality can be formed using halftone exposure, although described in detail below.

A light blocking layer which blocks light may be provided in the grid region. In this case, flicker can be more stably reduced.

The grid region may be formed to partially connect adjacent ones of the pixel counter regions together. Also in this case, flicker can be more stably reduced.

### Advantages of the Invention

As described above, according to the present invention, even when the frequency of the drive voltage is decreased, flicker can be effectively reduced. Therefore, the light blocking layer can be reduced, whereby the aperture ratio can be improved. As a result, display performance, such as luminance, contrast, etc., of a liquid crystal display device can be improved.

### BRIEF DESCRIPTION OF THE DRAWINGS

FIG. 1 is a perspective view schematically showing a display panel of a conventional liquid crystal display device.

FIG. 2 is a diagram for describing a flicker phenomenon during low-frequency drive. FIGS. 2(a) and 2(b) are plan views schematically showing a main portion of the conventional display panel, where a light blocking layer is not shown.

FIG. 3 is a cross-sectional view taken along arrowed line I-I in FIG. 2(a).

FIGS. 4(a) and 4(b) are conceptual diagrams showing states in which a drive voltage is reversed in the conventional liquid crystal display device.

FIG. 5 is a perspective view schematically showing an example liquid crystal display device to which the present invention is applied.

FIG. 6 is a perspective view schematically showing a display panel of the liquid crystal display device of FIG. 5.

FIG. 7 is a cross-sectional view schematically showing a portion of the display panel.

FIG. 8 is a plan view schematically showing a main portion of a TFT substrate.

FIG. 9 is a perspective view schematically showing a main portion of a counter substrate.

FIGS. 10(a) and 10(b) are conceptual diagrams showing states in which the drive voltage is reversed in the liquid crystal display device of this embodiment.

FIGS. 11(a) and 11(b) are plan views schematically showing display states the drive voltage is reversed in the liquid crystal display device of this embodiment.

FIGS. 12(a)-12(d) are diagrams schematically showing a process of manufacturing a counter substrate of this embodiment.

FIG. 13 is a cross-sectional view schematically showing a first variation. FIG. 13 corresponds to FIG. 7 of this embodiment.

FIGS. 14(a)-14(d) are diagrams schematically showing the process of manufacturing the counter substrate of a first variation.

FIG. 15 is a cross-sectional view schematically showing a second variation. FIG. 15 corresponds to FIG. 7 of this embodiment.

FIG. 16 is a perspective view schematically showing a variation of the counter electrode.

FIG. 17 is a perspective view schematically showing a variation of the counter electrode.

FIG. 18 is a cross-sectional view schematically showing a variation of the liquid crystal display device. FIG. 18 corresponds to FIG. 7 of this embodiment.

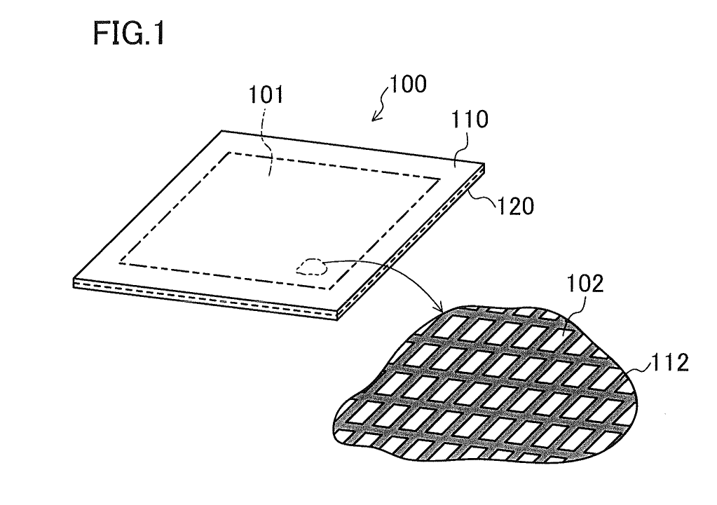

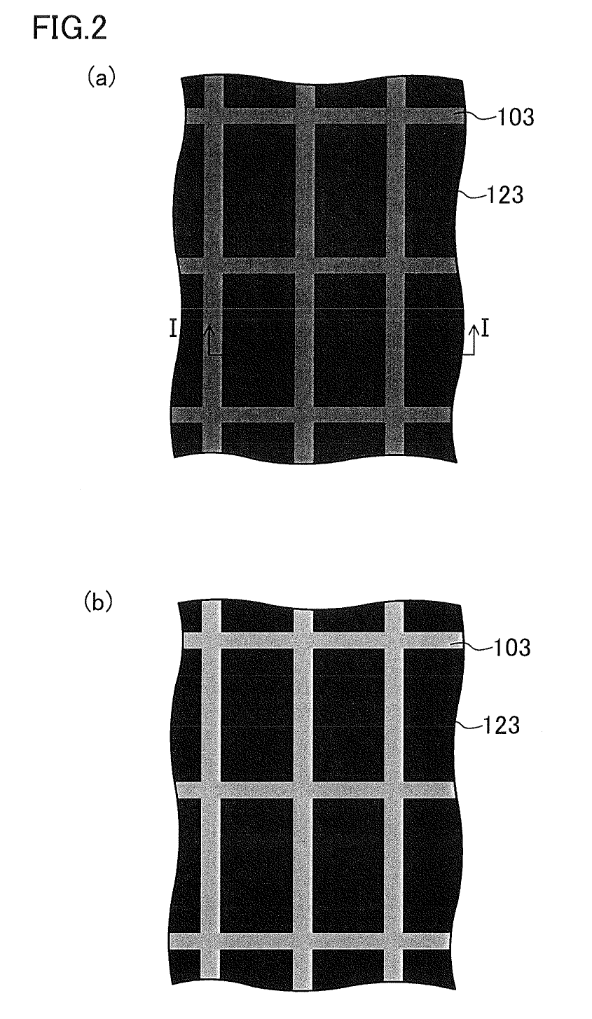

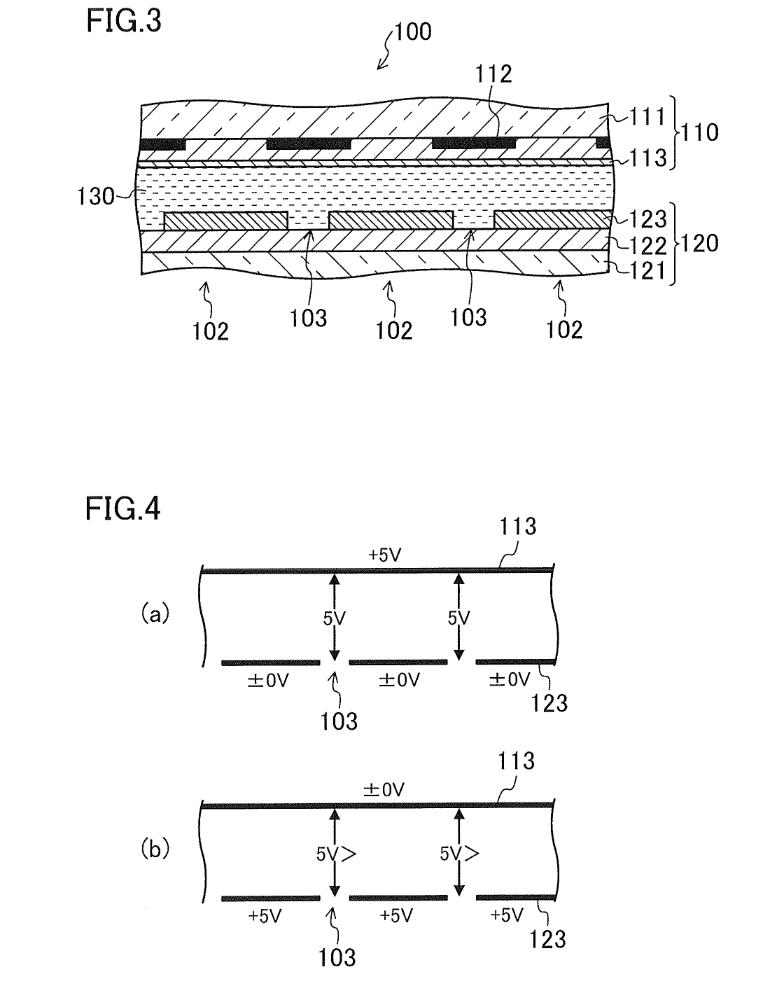

### DESCRIPTION OF EMBODIMENTS

Embodiments of the present invention will be described in detail hereinafter with reference to the accompanying drawings. Note that the embodiments described below are merely exemplary in nature and are in no way intended to limit the scope of the present disclosure or its application or uses.

FIG. 5 shows a liquid crystal display device 1 according to this embodiment. The liquid crystal display device 1 is, for example, a mobile information terminal, such as an electronic book, an electronic dictionary, etc., and has a function of displaying monochromatic images by an active matrix drive technique. The liquid crystal display device 1 includes a display panel 2 and a body housing 3 which houses the display panel 2. Various pieces of hardware and software, a battery, etc. (not shown) for driving and controlling the display panel 2 are mounted in the body housing 3.

The display panel 2 (hereinafter also simply referred to as a “panel 2”) of this embodiment is a normally white type liquid crystal panel whose light transmission is maximum in the absence of an applied voltage. A backlight is not provided, and displaying is performed using reflection of external light (reflection type). The supply of power to a backlight is not required, and therefore, long-time continuous displaying with less power consumption can be achieved.

Moreover, in the liquid crystal display device 1, the frequency of the drive voltage is, for example, 1-30 Hz, which is lower than a commonly used frequency of 60 Hz. The use of such a low frequency allows displaying with still lower power.

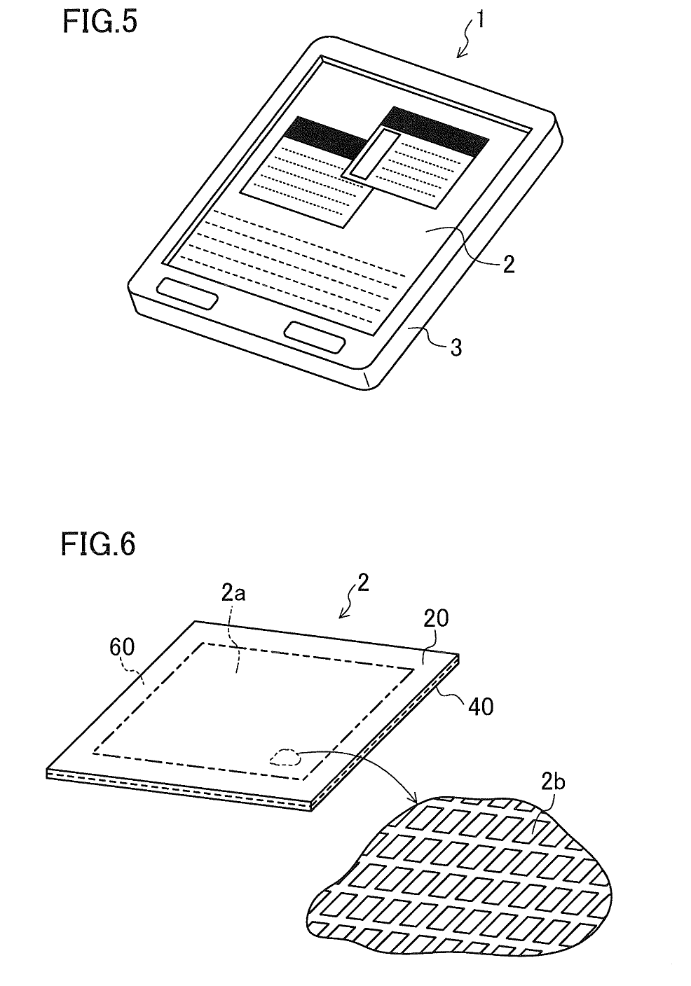

FIG. 6 shows the panel 2. The panel 2 has the same basic structure as that of the above conventional the display panel 100. Specifically, the panel 2 includes a counter substrate 20 which faces the display side, and a TFT substrate 40 which faces the counter substrate 20 with a small gap being interposed between the counter substrate 20 and the TFT substrate 40. A perimeter of the substrates 20 and 40 is sealed with a sealing material 60. A liquid crystal layer 70 is enclosed between the substrates 20 and 40. A display region 2a is formed at a middle portion of the panel 2 surrounded by the sealing material 60. A plurality of rectangular pixels 2b, 2b, . . . , and 2b are provided in a matrix in the display region 2a.

Note that the display region 2a of the panel 2 of this embodiment is not provided with a light blocking layer, unlike the panel of the conventional liquid crystal display device. Therefore, the aperture ratio is significantly increased, whereby the display performance is improved.

Because a light blocking layer is not provided, a portion in which flicker may occur is exposed. However, in this panel 2, the counter substrate 20 is devised to have a structure which does not cause discomfort to the viewer. The structure of the panel 2 will be described in detail hereinafter.

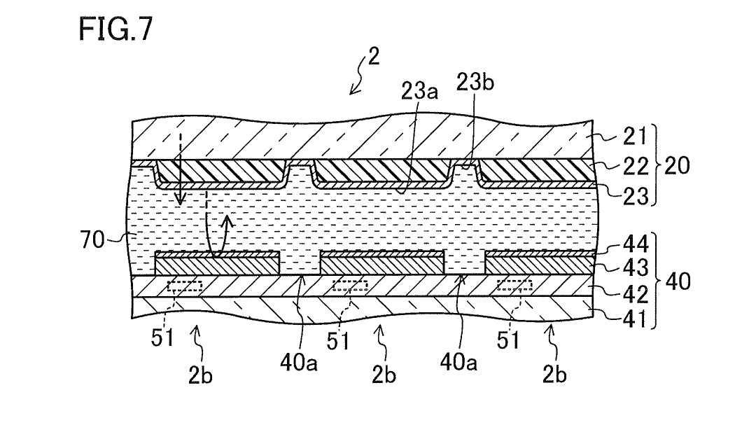

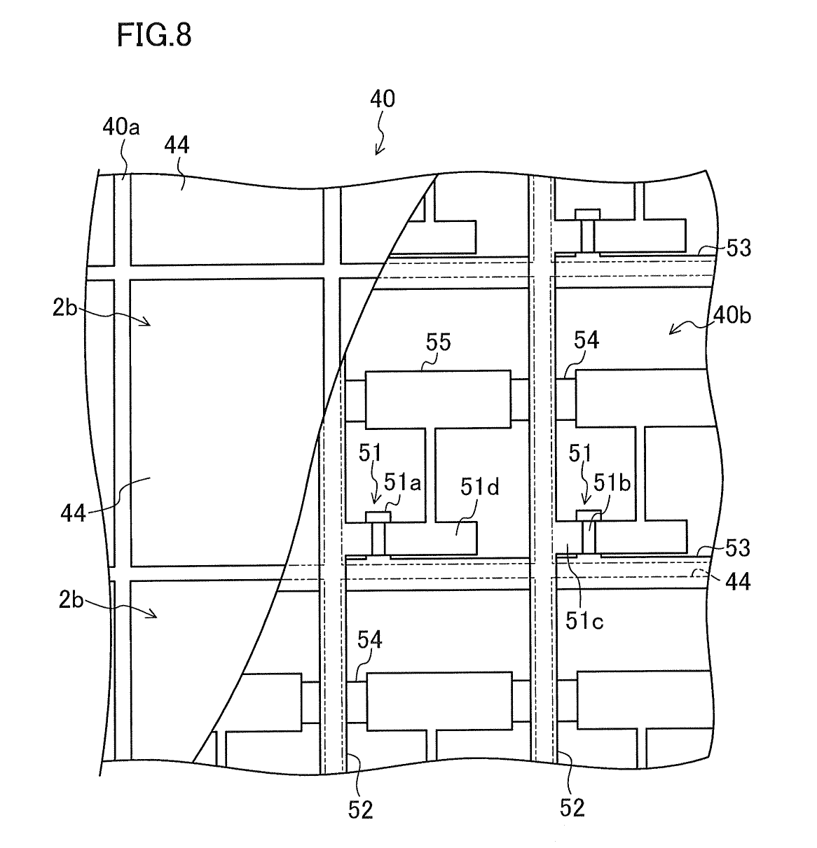

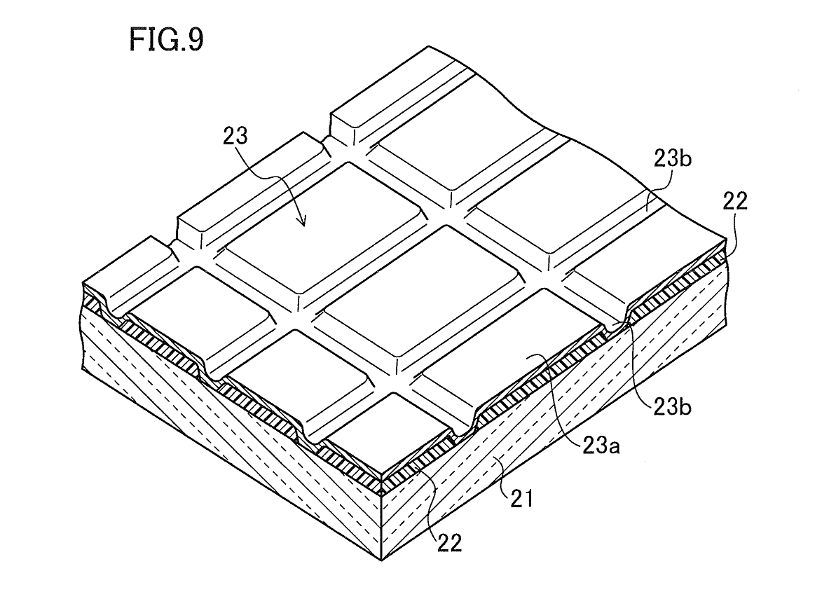

FIGS. 7-9 show the structure of the panel 2. FIG. 7 is a cross-sectional view schematically showing the display region 2a of the panel 2. FIG. 8 is a diagram schematically showing a portion of the display region 2a of the TFT substrate 40 as viewed from the counter substrate 20. FIG. 9 is a perspective view schematically showing a portion of the display region 2a of the counter substrate 20 as viewed from the TFT substrate 40.

As shown in FIGS. 7 and 8, the TFT substrate 40 includes a first insulating substrate 41, a TFT layer 42, a reflection layer 43, pixel electrodes 44, etc. As shown in FIGS. 7 and 9, the counter substrate 20 includes a second insulating substrate 21, raised layers 22, a counter electrode 23, etc. The panel 2 is of the reflection type. As indicated with a line with an arrow in FIG. 7, an image is displayed using external light which enters the panel 2 through the counter substrate 20 and is then reflected by the reflection layer 43. Each pixel 2b is changed to white or black by changing the alignment of liquid crystal molecules contained in the liquid crystal layer 70 by controlling a voltage applied between the pixel electrode 44 and the counter electrode 23. Note that, for the sake of simplicity, a polarizing plate, an alignment film, etc. are not shown.

The first insulating substrate 41 is a base member of the TFT substrate 40 which is formed of, for example, glass, resin, etc. and therefore has excellent insulating properties. Because the panel 2 of this embodiment is of the reflection type, the first insulating substrate 41 does not necessarily need to have the ability to transmit light. For example, the first insulating substrate 41 may be formed of a composite material which is a metal plate covered by an insulating material. The TFT layer 42 is provided on one surface (counter surface) of the first insulating substrate 41.

As shown in detail in FIG. 8, thin film transistors (TFTs) 51, source lines 52, gate lines 53, auxiliary capacitor lines 54, capacitors 55, etc., which are formed into respective shapes by patterning, are stacked on the TFT layer 42. Specifically, the source lines 52 and the gate lines 53 are provided in a grid pattern on the counter surface, extending vertically and horizontally while intersecting each other. The auxiliary capacitor line 54 is provided between two adjacent gate lines 53, extending in parallel to the gate line 53. The capacitor 55 is provided at a center portion of each of separate rectangular regions 40b of the grid pattern. The capacitor 55 is connected to the auxiliary capacitor line 54, and via the TFT 51 having a switch function to the source line 52.

The TFT 51 is provided in the vicinity of an intersection portion of the gate line 53 and the source line 52 (one TFT 51 is provided in each rectangular region 40b). The TFT 51 includes a gate electrode 51a connected to the gate line 53, a semiconductor 51b vertically facing the gate electrode 51a, a source electrode 51c connected to the source line 52, a drain electrode 51d connected via the semiconductor 51b to the source electrode 51c, etc. The gate line 53 and the gate electrode 51a are covered with a gate insulating film, on which the semiconductor 51b, the source electrode 51c, the drain electrode 51d, etc. are provided. The semiconductor 51b etc. are covered with an insulating protection film. Thus, the TFT layer 42 is formed. The pixel electrodes 44 are provided on the TFT layer 42 with the reflection layer 43 being interposed therebetween.

Each pixel electrode 44 has a rectangular shape corresponding to the shape of the rectangular region 40b. One pixel electrode 44 is provided in each rectangular region 40b for each pixel 2b. The pixel electrode 44 is connected via a contact hole to the drain electrode 51d of the TFT 51. The pixel electrode 44 of this embodiment is formed of indium tin oxide (ITO), which is a transparent electrode having excellent conductivity. The reflection layer 43 is provided directly blow the pixel electrode 44. The reflection layer 43 may be formed of for example, aluminum, aluminum alloy, etc.

The second insulating substrate 21 is a base member of the counter substrate 20 which has excellent insulating properties, as with the first insulating substrate 41. Note that an image is viewed through the second insulating substrate 21, and therefore, the second insulating substrate 21 needs to have an excellent ability to transmit light (light transmission capability). Therefore, the second insulating substrate 21 is preferably a glass substrate etc.

The raised layers 22 are provided on a surface (counter surface) of the second insulating substrate 21. Each raised layer 22 is in the shape of a rectangular platform corresponding to the shape of the pixel electrode 44, i.e., having a top surface which has substantially the same area as that of the pixel electrode 44. The raised layers 22 are arranged in a matrix, facing the respective corresponding pixel electrodes 44. An image is viewed through the raised layers 22, and therefore, the raised layers 22 need to have excellent light transmission capability.

The raised layer 22 needs to have a thickness of about several micrometers and be formed into a predetermined shape by patterning. Therefore, the raised layer 22 is preferably formed of a photosensitive resin material of which such a thin film can be stably formed and to which photolithography can be applied. If such a photosensitive resin is used, a material having excellent light transmission capability can be easily obtained, and the raised layers 22 can be relatively easily formed with high accuracy, resulting in high productivity.

The counter electrode 23 is provided on a surface of the second insulating substrate 21 on which the raised layers 22 are formed. The entire display region 2a of the counter electrode 23 is covered by the counter electrode 23. In other words, the single counter electrode 23 faces all the pixel electrodes 44. An image is viewed through the counter electrode 23, and therefore, the counter electrode 23 needs to have excellent light transmission capability, and is formed of ITO in this embodiment.

The counter electrode 23 is tightly attached to surfaces of the second insulating substrate 21 and the raised layers 22, and therefore, has a plurality of portions (pixel counter regions 23a) covering top surfaces of the raised layers 22, and a grid-shaped portion (a grid region 23b) which is a recessed portion located between each pixel counter region 23a, i.e., is lower than the pixel counter regions 23a, specifically, a portion covering a surface of the second insulating substrate 21 which is exposed between each raised layer 22.

As shown in FIG. 7, when the counter substrate 20 and the TFT substrate 40 are joined together, the pixel counter regions 23a are positioned to face the respective corresponding pixel electrodes 44, and the grid region 23b is positioned to face an isolation region 40a. In this case, the grid region 23b is located further away from a reference surface (e.g., a surface of the first insulating substrate 41) of the TFT substrate 40 than the pixel counter region 23a is, by at least 0.5 μm or more, preferably 1.5 μm (raised amount).

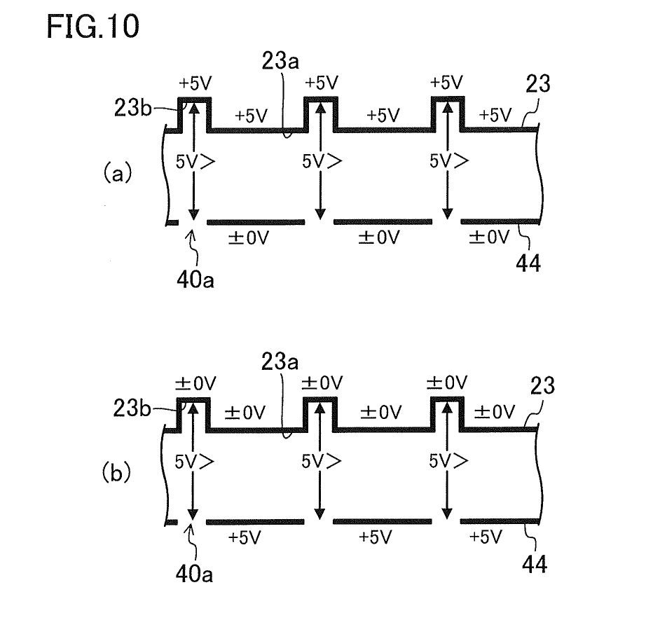

Also in the liquid crystal display device 1, the drive control of reversing the drive voltage at predetermined intervals (e.g., one second etc.) is performed in order to reduce image sticking etc. as in the conventional art. FIGS. 10(a) and 10(b) show two potential states which occur when the drive voltage is reversed while a voltage is applied to the pixel 2b, i.e., black is displayed.

FIG. 10(a) shows a state in which the counter electrode 23 has a higher potential than that of the pixel electrode 44, and FIG. 10(b) shows a state in which the counter electrode 23 has a lower potential than that of the pixel electrode 44. As shown in FIG. 10(a), for example, when the potential of the counter electrode 23 is 5 V and the potential of the pixel electrode 44 is 0 V, a potential difference of 5 V occurs at the pixel electrode 44. In contrast to this, in the isolation region 40a, the grid region 23b of the counter electrode 23 is located further away from the TFT substrate 40 than the pixel counter region 23a is, and therefore, a potential difference occurring therein is smaller than 5 V. In other words, the isolation region 40a appears whiter than the pixel electrode 44, i.e., appears gray as shown in FIG. 11(a).

On the other hand, as shown in FIG. 10(b), when the potential of the pixel electrode 44 is 5 V and the potential of the counter electrode 23 is 0 V, a potential difference of 5 V occurs at the pixel electrode 44 as in the case of FIG. 10(a), but the potential of the isolation region 40a remains 0V and a potential difference does not occur with respect to the counter electrode 23. Actually, even in the isolation region 40a, a potential difference (e.g., about 3 V) occurs due to an influence of the voltage applied to the pixel electrode 44. Therefore, the isolation region 40a appears gray.

In other words, in this case, even if the drive voltage is reversed, the voltage difference is reduced in the isolation region 40a, and therefore, the luminance difference which changes periodically is also reduced. As a result, even if the frequency of the drive voltage is decreased, the luminance change is difficult for the viewer to recognize. Therefore, even if a light blocking layer is not provided, discomfort is not caused to the viewer.

As the distance between the grid region 23b and the TFT substrate 40 increases, the isolation region 40a is caused to appear whiter when the potential of the counter electrode 23 is higher (FIG. 10(a)), which is more similar to the state in which the potential of the counter electrode 23 is lower (FIG. 10(b)). In order to effectively reduce flicker, the raised amount needs to be at least 0.5 μm or more, although it depends on the magnitude of the drive voltage or the structure of the pixel electrode 44 etc. If the raised amount is 1.5 μm or more, flicker can be effectively reduced or prevented even when the frequency is as low as 1-30 Hz etc.

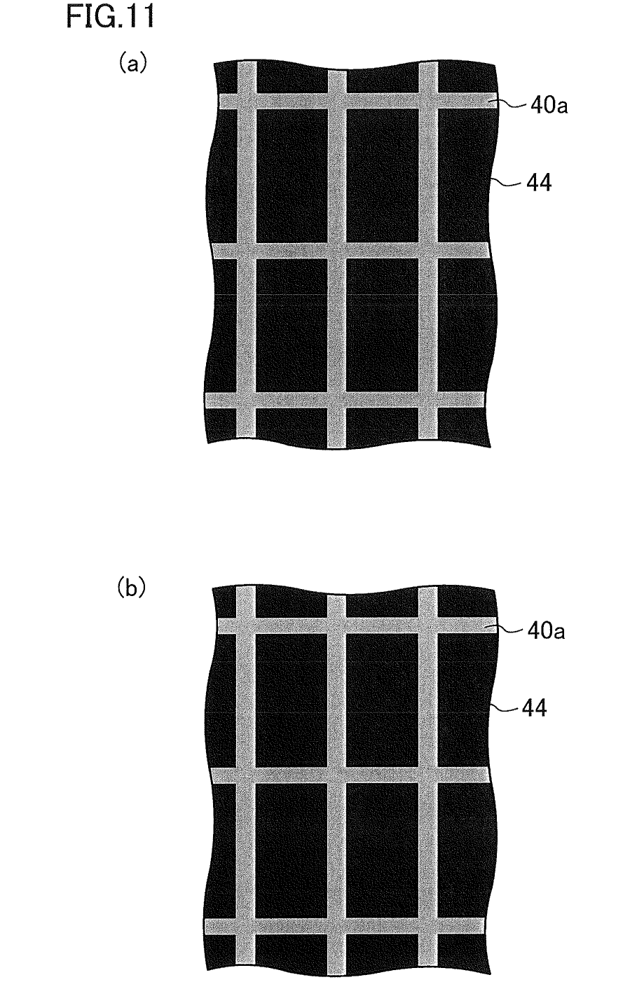

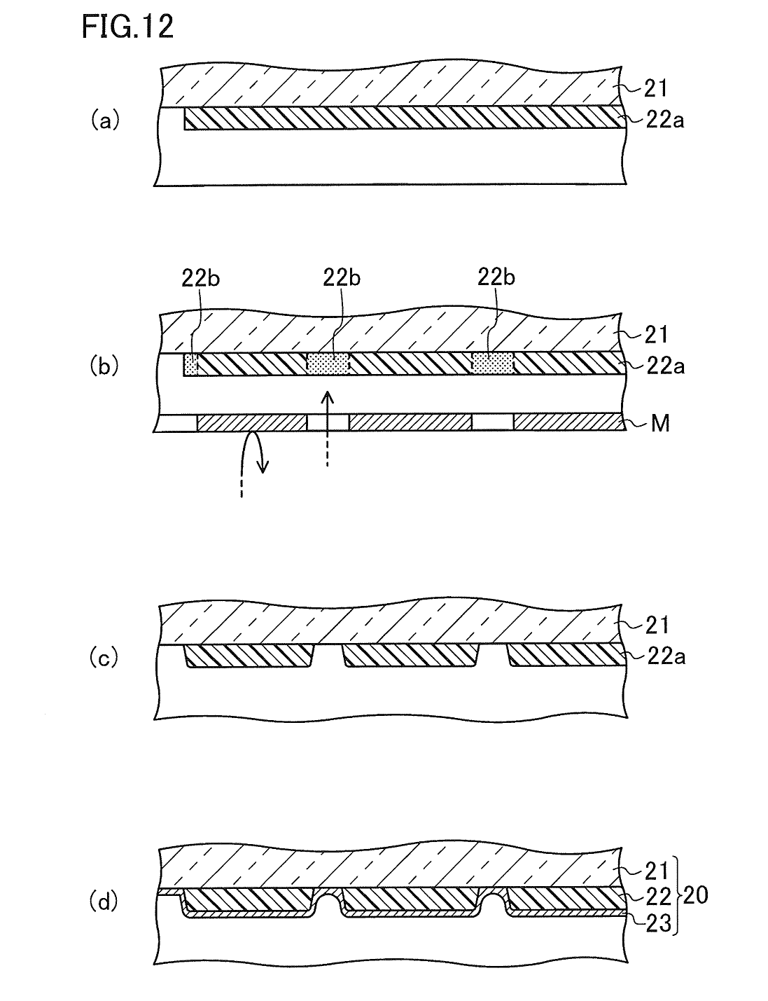

Next, a method for manufacturing the counter substrate 20 of this embodiment will be described with reference to FIG. 12. The counter substrate 20 having the above structure can be easily manufactured using, for example, photolithography.

Initially, as shown in FIG. 12(a), a photosensitive resin is applied to the display region 2a of the second insulating substrate 21 by spin coating etc. to form a photosensitive resin film 22a having a predetermined thickness (film formation step). Thereafter, as shown in FIG. 12(b), a photomask M having an opening corresponding to the grid region 23b is placed on top of the photosensitive resin film 22a, which is in turn irradiated with ultraviolet light (exposure step).

As shown in FIG. 12(c), the photosensitive resin film 22a which has been subjected to the exposure step is immersed in developer solution to remove a portion 22b which has been irradiated with ultraviolet light, whereby the raised layers 22 having a predetermined pattern are formed (development step). Thereafter, as shown in FIG. 12(d), an ITO film is formed on surfaces of the raised layer 22 etc. by sputtering etc. to form the counter electrode 23 (counter electrode formation step).

Note that the photosensitive resin may be of either the negative type or the positive type. If the photomask M matching the shape of the photosensitive resin is used, the raised layer 22 having a similar shape can be formed. A resist film (photosensitive resin) may be used to form the raised layer 22. In this case, the raised layer 22 can be formed of a commonly used resin.

<First Variation>

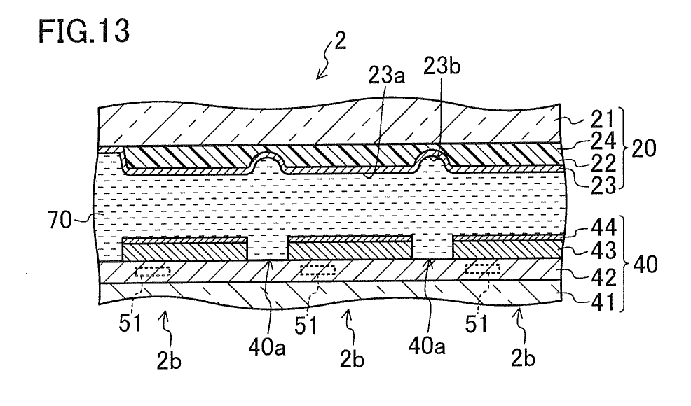

FIG. 13 shows a variation of the liquid crystal display device 1 of the present invention. This variation is different from the above embodiment mainly in which a base layer 24 is provided below the raised layers 22. The basic structure of this variation is the same as that of the above embodiment. Therefore, the difference will be described in detail. The same components are indicated by the same reference characters and will not be described (the same applies to variations etc. described below).

In the counter substrate 20 of this variation, the base layer 24 integrated with the raised layers 22 is provided below the raised layers 22. The base layer 24 is formed on the counter surface of the second insulating substrate 21, covering the entire display region 2a. The raised layers 22 having the above form are integrally formed on the base layer 24. Therefore, the grid region 23b which covers the surface of the second insulating substrate 21 in the above embodiment mainly covers a surface of the base layer 24 in this variation (there may be a portion of the second insulating substrate 21 which is covered by the grid region 23b).

The raised layers 22 and the base layer 24 may be simultaneously formed by photolithography using the same photosensitive resin material.

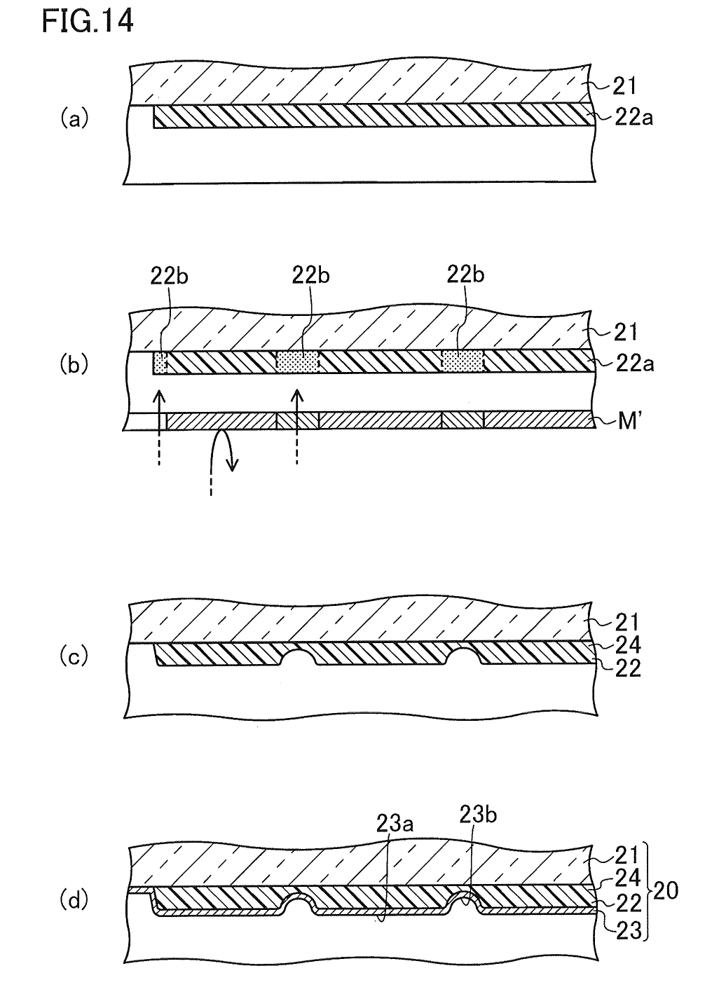

This variation will be described with reference to FIG. 14. Initially, as shown in FIG. 14(a), the photosensitive resin film 22a having a predetermined thickness is formed in a manner similar to that of the above embodiment (film formation step). Note that the photosensitive resin film 22a of this variation has a thickness including those of the base layer 24 as well as the raised layer 22. Thereafter, as shown in FIG. 14(b), a photomask M′ capable of halftone exposure (i.e., a portion thereof corresponding to the grid region 23b allows a larger amount of ultraviolet light to transmit therethrough than that of a portion thereof corresponding to the pixel counter region 23a) is used to perform exposure (halftone exposure step). Thereafter, as shown in FIG. 14(c), development is performed to form the raised layers 22 having a predetermined pattern (development step). Thereafter, as shown in FIG. 14(d), an ITO film is formed to form the counter electrode 23 (counter electrode formation step).

A portion (recess) corresponding to the grid region 23b is thus formed by halftone exposure, whereby the raised layer 22 can have a gentler edge than that of the above embodiment. The recessed portion corresponding to the grid region 23b of the raised layer 22 has a considerably large depth compared to the width. Therefore, if the edge is steep, the counter electrode 23 may be discontinued at the grid region 23b or the thickness may not be uniform. In contrast to this, by causing the edge to be gentle, the counter electrode 23 which is not discontinued even at the grid region 23b and has a uniform thickness can be formed.

In the film formation step, the raised layers 22 and the base layer 24 may be simultaneously formed or may be separately formed and stacked together. If the raised layers 22 and the base layer 24 are separately formed, a photosensitive resin film having a large thickness can be easily formed.

<Second Variation>

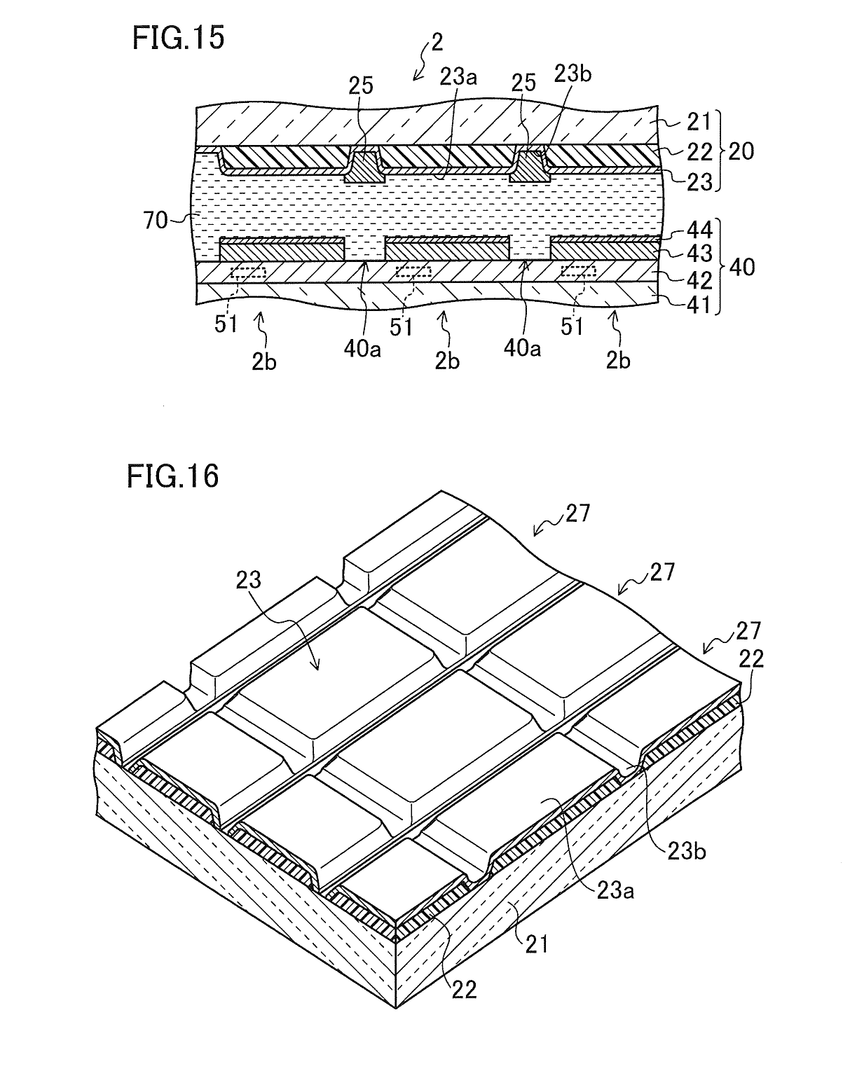

FIG. 15 shows a variation of the liquid crystal display device 1 of the present invention. This variation is different from the above embodiment etc. mainly in a light blocking layer 25 is provided.

In the liquid crystal display device 1 of this variation, the light blocking layer 25 which blocks light is provided only in the grid region 23b. Specifically, the light blocking layer 25 is provided to fill in a grid groove between adjacent pixel counter regions 23a. A conventional light blocking layer need to have a larger width than that of the isolation region 40a in order to hide flicker. This is not the case in this variation, because the occurrence of flicker is reduced.

Because the light blocking layer 25 is provided only in the grid region 23b in which a large change occurs in the luminance, flicker can be more stably and reliably reduced or prevented while the aperture ratio is improved.

—Variation of Counter Electrode 23—

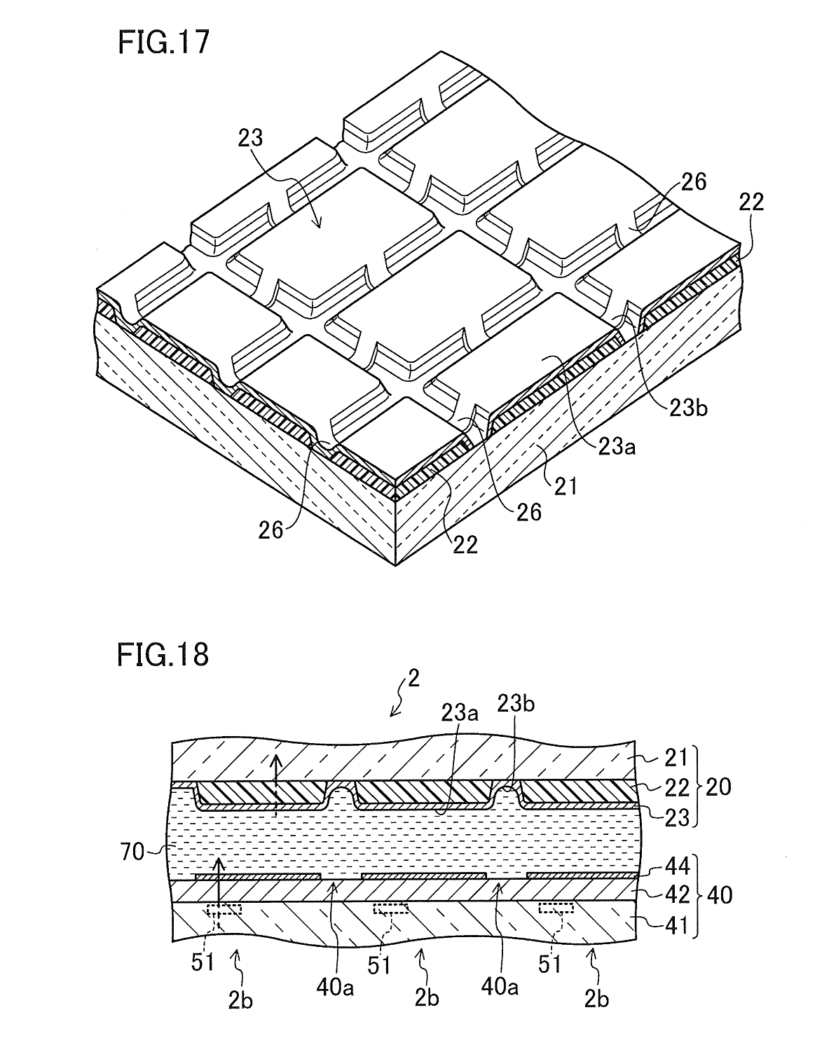

FIGS. 16 and 17 show a variation of the counter electrode 23. In the above embodiment, the counter electrode 23 completely covers the entire display region 2a. Alternatively, the grid region 23b may be formed so that adjacent pixel counter regions 23a may be partially connected together.

For example, as shown in FIG. 16, the counter electrode 23 may include band-like pixel counter region rows 27, 27, . . . , and 27 each of which includes the pixel counter regions 23a connected together and which are arranged in parallel to each other with a gap being interposed between adjacent pixel counter region rows 27. In this case, each of the pixel counter regions 23a included in each pixel counter region row 27 is connected to the pixel counter regions 23a adjacent thereto at one of either vertical ends or horizontal ends thereof. In addition, each pixel counter region row 27 is connected to each of the pixel counter region rows 27 adjacent thereto at at least one point. Thus, the counter electrode 23 is configured as a single electrode.

Alternatively, as shown in FIG. 17, in the counter electrode 23, each pixel counter region 23a may be connected to each of the pixel counter regions 23a adjacent thereto via a line (band)-like connection portion 26. Specifically, each pixel counter region 23a may be connected to each of the pixel counter regions 23a adjacent thereto at any point, and therefore, there may be a space in the grid region 23b. If a space is formed in the grid region 23b, the structure of the counter electrode 23 can be caused to be proportionately more similar to that of the pixel electrodes 44, whereby flicker can be more stably reduced or prevented. Note that the counter electrode 23 in such a form can be formed using etching technology.

—Variation of Liquid Crystal Display Device 1—

In the above embodiment etc., the reflection type liquid crystal display device 1 has been described as an example. As shown in FIG. 18, the present invention is also applicable to a transmission type liquid crystal display device. In the transmission type liquid crystal display device, a backlight can be used as a light source. In this case, the first insulating substrate 41 and the TFT layer 42 of the TFT substrate 40 need to have light transmission capability, and therefore, may be formed of a material having excellent light transmission capability. The reflection layer 43 is not required.

Note that the liquid crystal display device 1 of the present invention is not limited to the above embodiment and may have various other configurations.

For example, the present invention is also applicable to a liquid crystal display device which displays color images. In this case, the raised layers 22 may also function as a color filter. For example, the raised layers 22 may be formed in a matrix by repeatedly performing patterning using three photosensitive resins colored with R, G, and B. The three colored raised layers 22 may be provided at respective predetermined positions. In this case, the number of steps and the number of materials can be reduced, resulting in excellent productivity. Of course, color display may be achieved by providing a color filter separately from the raised layers 22.

The raised layer 22 and the counter electrode 23 may be integrally formed using ITO etc. In this case, for example, an ITO film having a predetermined thickness may be formed and thereafter etching may be performed on the ITO film, whereby the grid region 23b can be formed, and the counter electrode 23 having a form similar to that of the above embodiment can be formed. The present invention is not limited to a normally white type liquid crystal display device and is also applicable to a normally black type liquid crystal display device.

### INDUSTRIAL APPLICABILITY

The liquid crystal display device of the present invention is applicable to, for example, a display for a PC or a TV, a camcorder, a digital camera, a navigation system, an audio playback device (e.g., a car audio device, an audio component, etc.), a game device, a mobile information terminal (e.g., a mobile computer, a mobile telephone, a hand-held game device, an electronic dictionary, an electronic book, etc.), an home appliance (a refrigerator, an air conditioner, an air purifier, control terminals therefore, a liquid crystal clock, etc.), etc.

### DESCRIPTION OF REFERENCE CHARACTERS

1 LIQUID CRYSTAL DISPLAY DEVICE
2 DISPLAY PANEL
20 COUNTER SUBSTRATE
21 SECOND INSULATING SUBSTRATE
22 RAISED LAYER
23 COUNTER ELECTRODE
23a PIXEL COUNTER REGION
23b GRID REGION
40 TFT SUBSTRATE
40a ISOLATION REGION
40b RECTANGULAR REGION
41 FIRST INSULATING SUBSTRATE
42 TFT LAYER
43 REFLECTION LAYER
44 PIXEL ELECTRODE
70 LIQUID CRYSTAL LAYER

1. A liquid crystal display device comprising:
a counter substrate facing a display side;
a TFT substrate facing the counter substrate; and
a liquid crystal layer enclosed between the TFT substrate and the counter substrate,
wherein
the TFT substrate has, on a counter surface thereof, a plurality of pixel electrodes arranged in a matrix,
the counter substrate has, on a counter surface thereof, a single counter electrode having light transmission capability and facing the pixel electrodes,
display is performed by changing alignment of liquid crystal molecules contained in the liquid crystal layer by controlling voltages applied between the pixel electrodes and the counter electrode,
the voltages have a frequency of less than 60 Hz,
the voltages between the pixel electrodes and the counter electrode are periodically reversed,
the counter electrode includes
a plurality of pixel counter regions facing the respective corresponding pixel electrodes, and
a grid region between each of the pixel counter regions, and
the grid region is located further away from the TFT substrate than the pixel counter regions are.

2. The liquid crystal display device of claim 1, wherein
the frequency of the voltages is 1-30 Hz.

3. The liquid crystal display device of claim 1, wherein
the grid region is located further away from the TFT substrate than the pixel counter regions are, by at least 0.5 μm or more.

4. The liquid crystal display device of claim 1, wherein
the counter substrate further includes
an insulating substrate having light transmission capability, and
a plurality of raised layers provided on the counter surface of the insulating substrate, facing the respective corresponding pixel electrodes, having a platform-like shape, and having light transmission capability,
the counter electrode is provided on top of the raised layers, covering the raised layers, and
portions of the counter electrode covering the raised layers are the pixel counter regions, and a portion of the counter electrode covering a region between each of the pixel counter regions and lower than the pixel counter regions is the grid region.

5. The liquid crystal display device of claim 4, wherein
a base layer spreading along the counter surface and integrally formed with the raised layers is provided below the raised layers, and
the raised layers and the base layer are formed of a photosensitive resin.

6. The liquid crystal display device of claim 4, wherein
a light blocking layer which blocks light is provided in the grid region.

7. The liquid crystal display device of claim 4, wherein
the grid region is formed to partially connect adjacent ones of the pixel counter regions together.
